(19) United States
(12) Patent Application Publication
(10) Pub. No.: US 2026/0119180 A1
(43) Pub. Date: Apr. 30, 2026

(54) SOFTWARE COMPONENT INTEGRATION MANAGEMENT USING MULTIPLE RUNTIMES

(71) Applicant: SAP SE, Walldorf (DE)

(72) Inventors: Prajwal Gonsalves, Bangalaore (IN); Kanchana Suresh Telkar, Bangalore (IN); Mrutyunjay Padmasali Sidda, Bangalore (IN)

(21) Appl. No.: 18/926,926

(22) Filed: Oct. 25, 2024

(51) Int. Cl. G06F 9/38; G06F 11/07

(52) U.S. Cl. CPC G06F 9/3861; G06F 11/0766

(57) ABSTRACT

Various examples are directed to systems and methods for software integration using a first runtime and a second runtime. The first runtime may access a first message from a first software component to a second software component. The first runtime may execute a set of first runtime operations based on the first message. Responsive to an exception generated by at least one of the set of first runtime operations the first runtime may call a second runtime exception subprocess to process the exception. The second runtime may execute the second runtime exception process to process the exception. After executing the second runtime exception subprocess to process the exception, the first runtime may execute a first runtime exception subprocess to process the exception.

### BACKGROUND

An integration platform is a software application or set of software applications that is configured to integrate messaging between sets of different software components. For example, an integration platform may receive messages sent by one software component to another software component. Consider an example message from a sender software component to a receiver software component. The integration platform may perform various transformations on the message so that it may be successfully read and processed by the receiver software component. In some examples, the integration platform is configured to poll the sending software component to retrieve messages that are to be sent to the receiver software component.

### BRIEF DESCRIPTION OF DRAWINGS

The present disclosure is illustrated by way of example and not limitation in the following figures.

FIG. 1 is a diagram showing one example of an environment comprising an integration platform and various software components.

FIG. 2 is a diagram showing an arrangement of the integration platform of FIG. 1 showing the processing of a message that generates an exception at the runtime.

FIG. 3 is a diagram showing an arrangement of the integration platform of FIG. 1 showing the processing of a message that generates an exception at the first runtime.

FIG. 4 is a flowchart showing one example of a process flow that may be executed by the integration platform of FIGS. 1-3 to perform integration of a message from a sending software component to a receiving software component utilizing the first runtime and the second runtime.

FIG. 5 is a flowchart showing one example of a process flow that may be executed by the first runtime of the integration platform of FIGS. 1-3.

FIG. 6 is a flowchart showing one example of a process flow that may be executed by the second runtime of the integration platform of FIGS. 1-3.

FIG. 7 is a flowchart showing one example of a process flow that may be executed by the exception subprocess 130 of the second runtime of the integration platform of FIGS. 1-3.

FIG. 8 is a block diagram showing one example of an architecture for a computing device.

FIG. 9 is a block diagram of a machine in the example form of a computer system within which instructions may be executed for causing the machine to perform any one or more of the methodologies discussed herein.

### DETAILED DESCRIPTION

An integration platform, such as the SAP Integration Suite product available from SAP SE of Walldorf, Germany, may be configured to perform various operations to facilitate the exchange of messages between one or more sender components and one or more receiver components. For example, an integration platform may be programmed to route messages between software applications or components. The software components sending a message may be referred to as a sender component, and the software component receiving the message, after processing by the integration platform, may be referred to as a receiver component. It will be appreciated that the integration platform may support two-way messaging. For example, a single software component may be both a sender component and a receiver component.

The integration platform may be programmed to transform messages from a format received from the sender component and to a format expected by the receiver component. In some examples, the integration platform may also manage the configurations of the sender system and/or the receiver system. For example, the integration platform may manage the sending component to configure a user account that is associated with a sent message, permissions associated with the sent message, messaging policies, and/or the like. The integration platform may also configure the receiver system, for example, by specifying endpoints for various messages, credentials to access the receiver system with the message, and/or the like.

In some examples, an integration platform may be implemented utilizing multiple integration flows. An integration flow may include a set of operations executed by a runtime of the integration to interface with at least one particular sender component or at least one particular receiver component. In some examples, integration flows are individually programmable and deployable based on the needs of the entity utilizing the integration platform (sometimes referred to herein as the user entity). In some examples, integration flows generated by the user entity are based on templates, instructions, and/or the like provided by the developer of the integration platform, also referred to herein as the integration platform developer.

Consider an example in which an entity operates a source system that generates and/or uses master data. The entity may wish to make the master data available to other destination systems. The entity may utilize the integration platform as a middleware to replicate the master data so that a new state defined by the master data is also updated on the destination systems. In some examples, an entity utilizes an integration platform to integrate between multiple sets of sending and receiving components. For example, an entity may desire to interface between software components for different tasks including, for example, different database components, different entity resource planning components, and/or the like.

In some examples, an integration platform is also configured to implement one or more messaging policies, for example, as part of an application programming interface (API)-led integration arrangement. Policies govern aspects of messaging such as, for example, permissible identities and/or authentication statuses of sending software components, messaging rate limits, and/or the like. Consider another example in which a customer entity wishes to expose a backend component to one or more client components. The integration platform may act as a middleware implementing an API allowing customer software components to access the backend component while performing both integration and policy enforcement.

In some examples, it is desirable to arrange an integration platform to implement policy enforcement and integration functionality using different runtimes. For example, integration may involve complex processing requiring time and computing resources (e.g., more memory, processor capacity, and the like). On the other hand, policy enforcement may be performed with lightweight technology, allowing policy enforcement to be done quickly and using fewer computing resources. Also, in some examples, it is desirable to execute policy enforcement and integration independently to facilitate the configurability of policy enforcement. For example, it may be desirable to permit a modification of policies enforced by the integration platform. Performing policy enforcement with a separate runtime may streamline the process of modifying policy parameters.

In some examples, utilizing separate runtimes for policy and integration may permit the policy enforcement runtime to be built in a lightweight manner. For example, a policy enforcement runtime may omit various functionalities that are included in an integration runtime. For example, an integration runtime may include functionalities such as, for example functionalities for performing data transformations, functionalities interfacing with data loggers, and/or the like. In this way, the policy enforcement runtime may be configured to execute quickly using fewer computing resources. The lightweight nature of the policy enforcement runtime may also facilitate the configurability of policies.

Although utilizing multiple runtimes in an integration platform can provide advantages, as described herein, it may also generate challenges. For example, integration platforms may encounter exceptions. An exception may occur if an integration platform operation fails, such as a policy enforcement operation or an integration operation. When an exception occurs during the processing of a message, the integration platform may perform one or more remedial actions that may include, for example, logging data describing the exception and reversing any policy and/or integration operations that were completed for the message before the exception occurred.

In some examples, remedial actions in response to an exception utilize functionality that it may otherwise be desirable to omit from a lightweight policy enforcement runtime. For example, a remedial action in response to an exception may include executing a data transformation to transform some or all of the incoming message to a format that is readable by the receiving software component. Another remedial action might include making log data available to the receiving component to inform the receiving component of the message and/or the encountered exception. Including functionalities such as data logging and data transformation into a policy runtime for exception handling purposes may reduce and, in some examples, eliminate the advantages of a multi-runtime integration platform arrangement.

Various examples address these and other challenges utilizing a multi-runtime integration platform arrangement that is configured to respond to exceptions by executing exception subprocesses at more than one runtime. Consider an example integration platform arrangement comprising a first runtime, which may be a lightweight policy enforcement runtime, and a second runtime, which may be an integration runtime including additional functionality. If an exception occurs in one or more operations of the first runtime, the first runtime may call an exception subprocess at the second runtime. The exception subprocess at the second runtime may execute in response to the exception at the first runtime. For example, the exception subprocess at the second runtime may execute remedial operations utilizing functionality included in the second runtime such as, for example, data logging and/or data transformation. After execution of the exception subprocess at the second runtime, the second runtime may also call an exception subprocess at the first runtime. The exception process at the first runtime may also execute in response to the exception at the first runtime. For example, the exception process at the first runtime may execute remedial operations that do not utilize functionality that is included at the second runtime, but not at the first runtime.

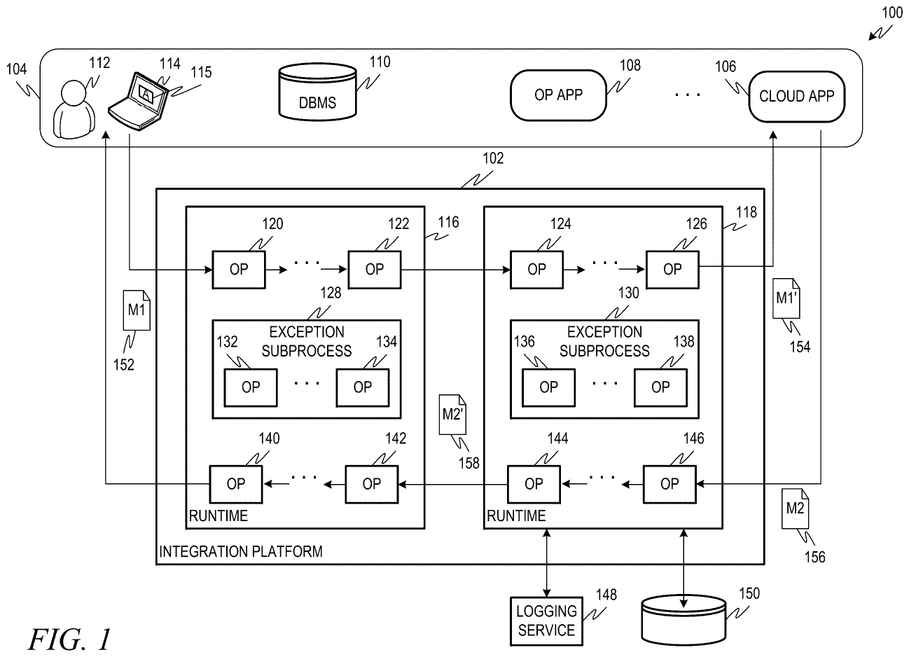

FIG. 1 is a diagram showing one example of an environment 100 comprising an integration platform 102 and various software components 104. The integration platform 102 is configured to integrate messaging between one or more of the software components 104. In some examples, the integration platform 102 is configured to provide integration as well as messaging policy enforcement, for example, as part of an API-led integration arrangement.

The integration platform 102 may be or include executable software implemented at an on-premise computing system and/or in a cloud environment. When the integration platform 102 is implemented by an on-premise computing system, a customer entity may obtain software for executing the integration platform 102 from a software provider entity. The customer entity may maintain computer hardware for implementing the integration platform 102, for example, on the customer entity's own premises.

In a cloud environment, a hyperscaler or other cloud service provider provides computing hardware for executing the integration platform 102. A cloud environment may be a public cloud environment or a private cloud environment. In a private cloud environment, the customer entity may obtain executables and other files for executing the integration platform 102 from a software provider entity and provide the received software to the cloud service provider. In a public cloud environment, the software provider entity provides executables and other files for executing the integration platform 102 the cloud service provider. This software is made available to users and/or software components associated with the customer entity using a tenancy of the public cloud environment. Different customer enterprises may utilize different versions of the integration platform installed and maintained by the customer entity at different tenancies. The software provider entity may also maintain the integration platform 102 and the various tenancies.

The integration platform 102 manages messaging between two or more software components, such as example software components 104. The example software components 104 include a cloud application 106, an on-premise executed application 108, a DBMS 110, and a user application 115. The cloud application 106 may be executed in a cloud environment such as a public cloud environment or a private cloud environment. Although a single cloud application 106 is shown, it will be appreciated that the integration platform 102 may manage messaging for more than a single cloud application.

The on-premise application 108 is executed at an on-premise computing system. For example, an entity utilizing the on-premise application 108 may maintain one or more servers, network equipment components, and or the like to implement the on-premise computing system. The on-premise application 108 may be implemented by executing appropriate software at the on-premise computing system. Although a single on-premise application 108 is shown, it will be appreciated that the integration platform 102 may manage messaging for more than a single on-premise application.

The DBMS 110 may be implemented, for example, in a cloud environment and/or in an on-premise environment. The DBMS 110 may implement a database management system that may be associated with one or more client applications. In some examples, the DBMS 110 may be or include a database management system, such as S/4 HANA™, SAP Concur®, SAP Successfactors®, SAP Data Warehouse Cloud, Inbound Document (IBD), available from SAP SE of Walldorf, Germany. Other examples of cloud-delivered data sources may include Structured Query Language (SQL) database services such as, for example, BigQuery® available from Google, LLC of Mountain View, California, Sharepoint® available from Microsoft Corporation of Redmond, Washington, various data storage products available from Salesforce, Inc. of San Francisco, California, and/or the like.

The user application 115 may execute at a user computing device 114 associated with a user 112. The user computing device 114 may be or include any suitable computing device such as, for example, a mobile computing device, a laptop computing device, a desktop computing device, and/or the like.

In some examples, one or more cloud applications 106, on-premise applications 108, and/or DBMSs 110 may implement a backend component that uses the integration platform 102 to expose an API-led integration to one or more client components. Client components may include cloud applications such as the cloud application 106, on-premise applications such as the on-premise application 108, user computing device-executed applications such as the user application 115, and/or the like. In some examples, the user application 115 is a client application that is configured to communicate with a backend application such as, for example, the on-premise application 108 or the cloud application 106. The integration platform 102 may provide messaging integration between the backend component and one or more of the client components.

It will be appreciated that the software components 104 are examples of software components that can be managed by the integration platform 102. In many example systems, the integration platform 102 will manage messaging between combinations of more than the three example software components 104 shown and FIG. 1. Also, it will be appreciated that the types of example software components 104 shown in FIG. 1 are provided for example purposes and are not exhaustive. Other types of applications in other combinations may be managed by an integration platform.

The example of FIG. 1 shows the integration platform 102 comprising two runtimes, a first runtime 116 and a second runtime 118. The first runtime 116 and second runtime 118 are labeled first and second for convenience of reference. It will be appreciated that the runtimes 116, 118 may be executed in any suitable order. For example, as illustrated by FIG. 1 and described herein, the second runtime 118 is executed prior to the first runtime 116 for the example message 156.

In some examples, the first runtime 116 is a policy enforcement runtime and may be a lightweight runtime. For example, the first runtime 116 may omit functionality for data transformations, logging, and/or the like. The second runtime 118 may be an integration runtime and may include functionalities for data transformations, logging, and/or the like.

In the example arrangement of FIG. 1, the integration platform 102 provides integration for messages between the cloud application 106 and the user computing device user application 115. It will be appreciated, however, the integration platform 102 may provide integration between any other two software components of the example software components 104.

The user application 115 may send a message 152 directed to the cloud application 106. The message 152 may be directed to the integration platform 102. The integration platform 102 may route the message 152 to the first runtime 116. The first runtime 116 may execute a policy flow comprising operations 120, 122. Each operation 120, 122 may apply all or part of a policy to the message 152. Applying a policy to a message may comprise examining the message and/or metadata describing the message and comparing the message to one or more predetermined policy rules. Various different policies may be applied.

Consider an example message rate limit policy. For example, the integration platform 102 may be configured to permit the user application 115 to send the messages to the cloud application 106, but not exceeding a threshold rate. Accordingly, one of the operations 120, 122 may process the message 152 to determine if it exceeds the permissible rate of messages from the user application 115. In some examples, the operation 120, 122 may maintain a counter or other record of messages from the user application 115 that have been received within a threshold time. For example, if the message rate limit for the user application 115 is 10 messages per second, then the operation 120, 122 implementing the rate limit policy may maintain a counter indicating the number of messages received from the user application 115 in the previous second. If the new message 152 causes the counter to exceed the allowable rate, then the operation 120, 122 may generate an exception.

Consider an example authentication policy. For example, the integration platform 102 may be configured to permit messages from the user application 115 to the cloud application 106 only if the user application 115 has been authenticated, for example, to a third-party identity service. One of the operations 120, 122 may process the message 152 to determine if the user application 115 has been authenticated per the policy. For example, the operation 120, 122 may use a public cryptographic key associated with the user application 115 to verify that a cryptographic signature included with the message 152 was generated using a secret private cryptographic key of the user application 115. If the authentication cannot be verified, then the operation 120, 122 may result in an exception.

In another example, an authentication policy may require that the user application 115 be authenticated using a particular authentication protocol such as, for example, OAuth. If the user application 115 has not been authenticated using the particular authentication protocol, then the operation 120, 122 implementing the policy may generate an exception.

Consider another example policy limiting the complexity of data structures included with incoming messages. For example, a malicious actors may against the integration platform 102 and/or the receiving software component by including with a message a data structure, such as a JavaScript Object Notation (JSON) data structure, with a number of complex, sometimes nested elements. To mitigate this risk, an example policy may limit the complexity of data structures included in incoming messages. In some examples, such a policy may limit the maximum number of elements in a data structure, the maximum depth of a data structure, the maximum object count a maximum name length of the data structure, a maximum string value length of the data structure, a maximum size of the data structure, and/or the like.

Another example policy is an address filter policy. For example, an address filter policy may filter or prevent transmission of messages from an address or addresses (e.g., Universal Resource Locator (URL) or other address). The address or addresses may correspond to a sending software components that are not permitted to send messages to the receiving software component. If the message 152 passes all the policies implemented by the various operations 120, 122 without generating an exception, the first runtime 116 may call the second runtime 118 to perform operations 124, 126 on the message 152. The operations 124, 126 may be integration operations and/or may implement an integration flow. In some examples, the last operation 122 to execute at the first runtime 116 is configured to call the first operation 124 to execute at the second runtime 118. Each integration operation 124, 126 may implement an integration task such as, for example, a data transformation, a logging operation, and/or the like.

Consider an example data transformation. Such an operation 124, 126 may be configured to modify a data model or format of the message 152 to a data model or format that is readable by the cloud application 106. This may result in a transformed message 154. Example data transformations that may be performed by one or more of the operations 124, 126 include an extensible markup language (XML) to JSON transformation, an XML to Comma Separated Values (CSV) transformation, a JSON to XML transformation, a JSON to CSV transformation, a CSV to XML transformation, a CSV to JSON transformation, and/or the like. Such transformations may also include, for example, adding a wrapper element to the message with additional details such as, for example, biographical or other identifying information about the user application 115.

In some examples, one or more of the operations 124, 126 may include data logging. For example, an operation 124, 126 may be configured to create log data describing the message 152. Log data may be provided to an external logging service 148. The logging service 148 may provide the log data to the cloud application 106. In other examples, log data may be provided to a data store 150 where, for example, it may be made available to the cloud application 106.

If one or more of the operations 124, 126 fails, an exception may occur. If all of the operations 124, 126 are successful, the result may be a transformed message 154 that is provided, for example, by the last operation 126, to the cloud application 106.

FIG. 1 also shows a flow for a message 156 sent by the cloud application 106 to the user application 115. This message 156 may be provided to the second runtime 118 which may execute an integration flow including operations 144, 146. Operations 144, 146 may implement integration including, for example, logging and/or data transformation. If any of operations 144, 146 fail, it may result in an exception. If operations 144, 146 succeed, it may result in a transformed message 158. The second runtime 118 may call the first runtime 116 to execute policy operations 140, 142 with respect to the transformed message 158. If any of the policy operations 140, 142 fail, an exception may be generated. If all the policy operations 140, 142 succeed, then the transformed message 158 may be provided to the user application 115. It will be appreciated that the respective runtimes 116, 118 may implement more or fewer operations 120, 122, 124, 126, 140, 142, 144, 146 than are shown in FIG. 1.

The respective runtimes 116, 118 also comprise exception subprocesses 128, 130. The respective exception subprocesses 128, 130 may execute various exception operations 132, 134, 136, 138 that implement remedial actions in response to an exception. As described herein, some remedial actions may utilize functionality that is included in the second runtime 118 but not included in the first runtime 116. The integration platform 102 may be configured to utilize the functionality of the second runtime 118 to respond to exceptions generated at the first runtime 116. As a result, the integration platform 102 may be configured to always execute the exception subprocess 130 of the second runtime 118, even when an exception originates from the first runtime 116. For example, if an operation 120, 122, 140, 142 of the first runtime results in an exception, the first runtime 116 may call the exception subprocess 130 of the second runtime 118. Similarly, if an operation 124, 126, 144, 146 of the second runtime 118 results in an exception, the second runtime 118 may also call its exception subprocess 130.

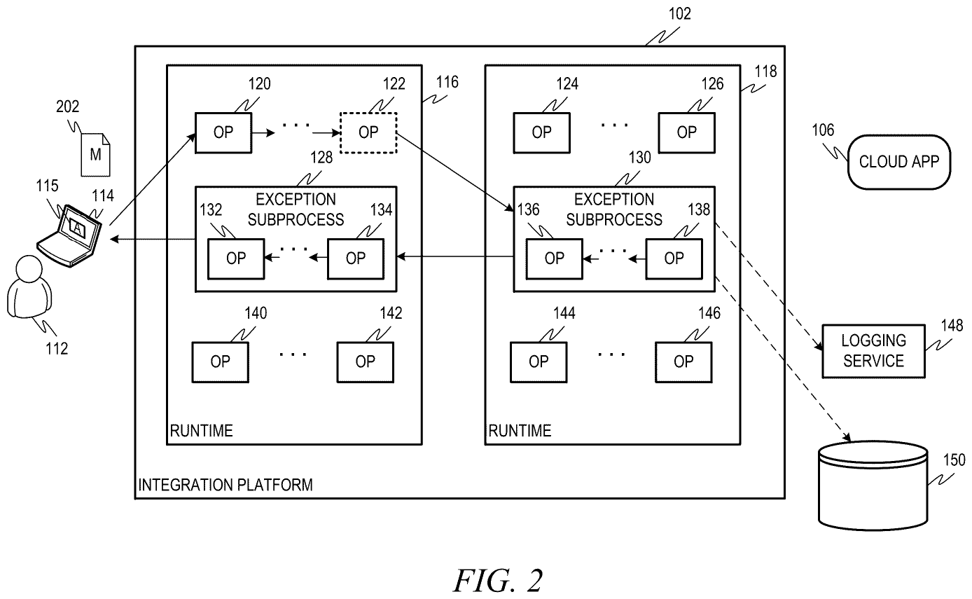

FIG. 2 is a diagram showing an arrangement of the integration platform 102 of FIG. 1 showing the processing of a message 202 that generates an exception at the first runtime 116. In this example, the message 202 is sent from the user application 115 to the cloud application 106. It will be appreciated, however, that the arrangement of FIG. 2 may be used for messages between any software components, such as the example software components 104.

In the example of FIG. 2, the message 202 is provided to the first runtime 116 which implements the policy operations 120, 122. In this example, the message 202 passes the policy operation 120, but fails the policy operation 122, resulting in an exception. In response to the exception, the first runtime 116 calls the exception subprocesses 130 of the second runtime 118.

The exception subprocess 130 may execute exception operations 136, 138 to process the exception at the policy operation 122. The exception operations 136, 138 executed by the exception subprocess 130 may include actions that utilize functionality that is included in the second runtime 118 and may be omitted in the first runtime 116. This may include, for example, executing one or more data transformations on some or all of the message 202. This may also include, for example, writing log data describing the exception and/or the message 202 to the logging service 148 and/or the log data store 150.

Upon completion of the exception operations 136, 138, the second runtime 118 may call the exception subprocess 128 of the first runtime 116. In some examples, the exception subprocess 130 of the second runtime 118 is configured to call the exception subprocess 128 of the first runtime 116 upon completion of the exception operations 136, 138. Also, in some examples, another component of the second runtime 118 is configured to call the exception subprocess 128 of the first runtime 116 upon completion of the exception operations 136, 138.

The exception subprocess 128 may execute policy exception operations 132, 134 to process the example exception at policy operation 122. Policy exception operations 132, 134 may, for example, reverse actions taken by policy operations 120, 122 prior to the exception. Consider an example in which the policy operation 120 implements a message rate limiter. In this example, a policy exception operations 132, 134 may determine whether a message rate counter was incremented for the message 202. If the message rate counter was incremented for the message 202, then the policy exception process may decrement the counter. In this way, the message 202, which was not successfully delivered, may not count against the rate limit of the user application 115.

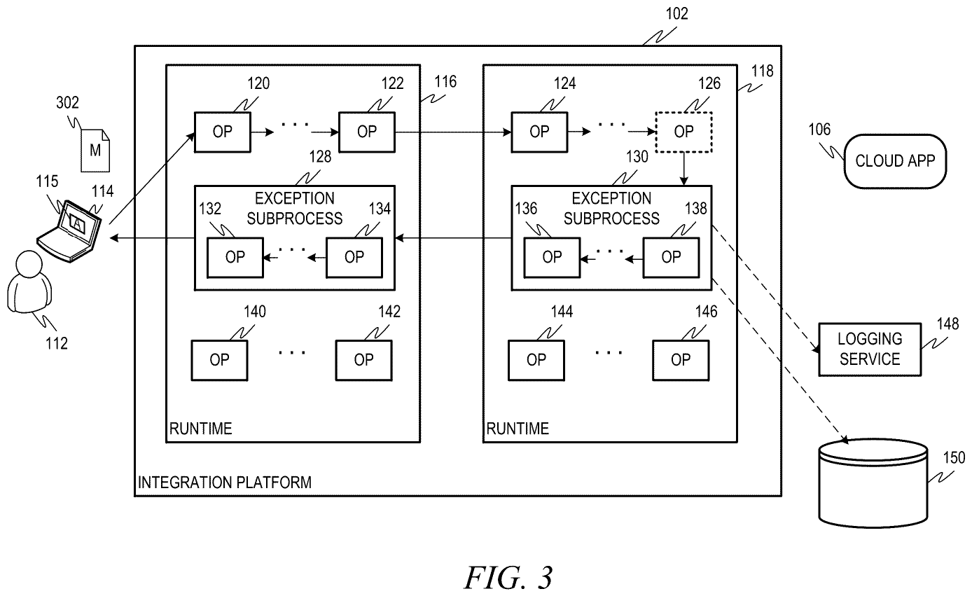

FIG. 3 is a diagram showing an arrangement of the integration platform 102 of FIG. 1 showing the processing of a message 302 that generates an exception at the second runtime 118. In this example, the message 302 is sent from the user application 115 to the cloud application 106. It will be appreciated, however, that the arrangement of FIG. 3 may be used for messages between any software components, such as the example software components 104.

In the example of FIG. 3, the message 302 is provided to the first runtime 116 which implements the policy operations 120, 122. In this example, the policy operations 120, 122 do not generate an exception. Accordingly, the second runtime 118 is called to implement an integration flow including operations 124, 126. In this example, the operation 126 generates an exception. In response to the exception, the operation 126 and/or another component of the second runtime 118 calls the exception subprocess 130 of the second runtime 118.

The exception subprocess 130 may execute exception operations 136, 138 to process the exception at the operation 126. Upon completion of the exception operations 136, 138, the second runtime 118 may call the exception subprocess 128 of the first runtime 116. The exception subprocess 128 may execute policy exception operations 132, 134 to process the example exception at operation 126.

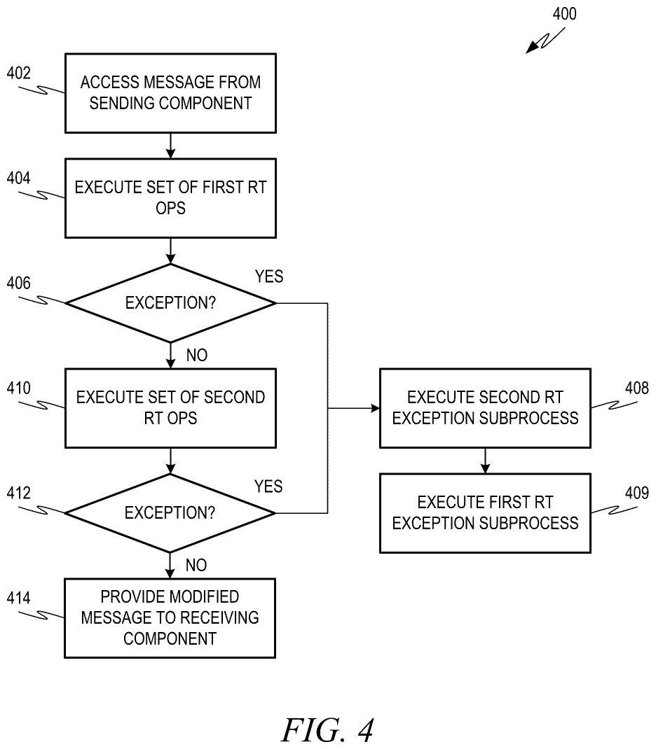

FIG. 4 is a flowchart showing one example of a process flow 400 that may be executed by the integration platform 102 of FIGS. 1-3 to perform integration of a message from a sending software component to a receiving software component utilizing the first runtime 116 and the second runtime 118 of the integration platform 102. In some examples, the first runtime 116 is arranged to implement policy enforcement operations and the second runtime 116 is configured to implement integration operations, for example, according to one or more integration flows.

At block 402, the integration platform 102 may receive a message from a sending software component. At block 404, the integration platform may execute a set of one or more first runtime operations 120, 122, 140, 142 based on the message. The first runtime operations 120, 122, 140, 142 may be executed by the first runtime 116. In some examples, the first runtime operations 120, 122, 140, 142 include policy enforcement operations, as described herein.

At block 406, the integration platform 102 determines if any of the first runtime operations 120, 122, 140, 142 have resulted in an exception. If an exception is detected, the integration platform 102 may execute an exception process of the second runtime 116. This may include executing a set of one or more exception operations at the second runtime 116. After executing the set of one or more exception operations at the second runtime 116, the integration platform 102 may execute an exception process of the first runtime 116 at block 409. This may include executing a set of one or more exception operations at the first runtime 116. In some examples, the order of blocks 408 and 409 may be reversed. For example, the integration platform 102 may execute the first runtime exception subprocess 128 first and then execute the second runtime exception process. In some examples the first runtime and/or the second runtime may be configured to send an exception completion message after completing its respective exception subprocesses. The exception completion message may indicate that exception processing has occurred. The exception completion message may be sent to the sending component and/or to the receiving component.

If no exception is generated by executing the set of first runtime operations 120, 122, 140, 142 at block 404, the integration platform 102 may execute a set of one or more second runtime operations 124, 126, 144, 146 at block 410. The one or more second runtime operations 124, 126, 144, 146 may be executed by the second runtime 116 and may include operations lamenting an integration flow. At block 412, the integration platform 102 may determine if any of the second runtime operations 124, 126, 144, 146 generated an exception. If an exception was generated, the integration platform 102 may execute the second runtime exception subprocess 130 and first runtime exception subprocess 128 respectively at blocks 408 and 409. If no exceptions occur, the integration platform 102 may provide a transformed message, generated by the second runtime operations 124, 126, 144, 146, to the receiving software component at block 414.

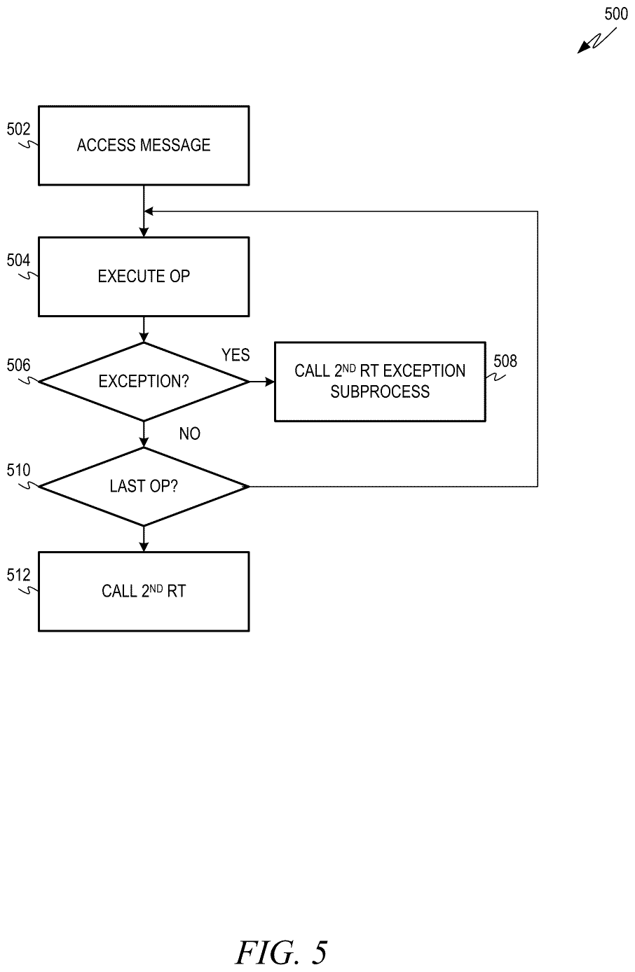

FIG. 5 is a flowchart showing one example of a process flow 500 that may be executed by the first runtime 116 of the integration platform 102 of FIGS. 1-3. The process flow 500 describes executing the operations 120, 122 of the first runtime 116. At block 502, the first runtime 116 may access a message from a sending software component to a receiving software component. At block 504, the first runtime 116 may execute a first operation 120, 122 based on the message. At block 506, the first runtime 116 may determine if the operation executed at block 504 resulted in an exception. If the operation resulted in an exception, the first runtime 116 may call the second runtime exception subprocess 130 at block 508. In some examples, the operation that generated the exception may call the second runtime exception subprocess 130.

At block 510, the first runtime 116 may determine whether operation executed at block 504 is the last operation of the first runtime 116 to be executed. If it is not, the first runtime 116 may return to block 504 and execute the next operation. If the operation executed at block 504 is the last operation of the first runtime 116 to be executed, the first runtime 116 may call the second runtime 118 at block 512. For example, the second runtime 118 may be called to execute operations implementing an integration flow for the received message.

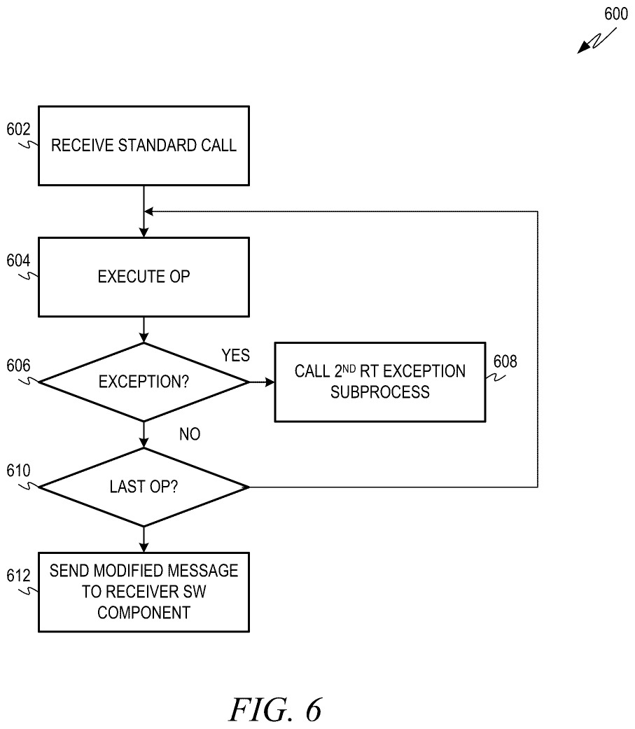

FIG. 6 is a flowchart showing one example of a process flow 600 that may be executed by the second runtime 118 of the integration platform 102 of FIGS. 1-3. The process flow 600 describes executing the operations 124, 126 of the second runtime 118. At block 602, the second runtime 118 may receive a standard call from the first runtime 116. For example, the first runtime 116 may execute its operations based on a message received from a sending component without an exception and call the second runtime 118 to continue processing the received message, such as described herein with respect to block 512.

At block 604, the second runtime 118 may execute an operation such as, for example, one of operations 124, 126. At block 606, the second runtime 118 may determine if the operation executed at block 604 resulted in an exception. If the operation executed at block 604 resulted in an exception, then the second runtime 118 may call the second runtime exception subprocess 130 at block 608. If the operation executed at block 604 did not result in an exception, then the second runtime 116 may determine, at block 610, whether the operation executed at block 604 is the last operation 124, 126. If the operation executed at block 604 is not the last operation, the second runtime 118 may return to block 604 and execute the next operation of the operations 124, 126. If the operation executed at block 604 is the last operation, the second runtime 118 may send a transformed message generated by the various operations 124, 126 to a receiver software component at block 612.

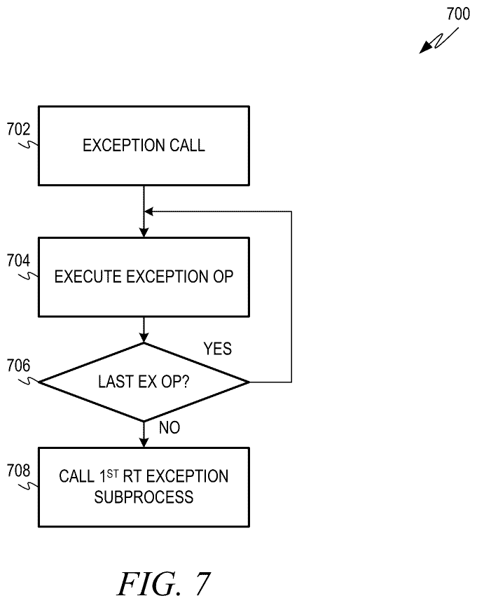

FIG. 7 is a flowchart showing one example of a process flow 700 that may be executed by the exception subprocess 130 of the second runtime 118 of the integration platform 102 of FIGS. 1-3. At block 702, the exception subprocess 130 may receive an exception call. The exception call may indicate that an exception has been generated with respect to a message. In some examples, the exception call originates from the first runtime 116 (or an operation 120, 122, 140, 142 thereof) such as described with respect to block 508 of the process flow 500. In other examples, the exception call originates from the second runtime 118 (or an operation 124, 126, 144, 146 thereof) such as described with respect to block 608 of the process flow 600.

At block 704, the exception subprocess 130 executes an exception operation, such as one of the operations 136, 138. At block 706, the exception subprocess 130 determines if the exception operation executed at block 704 is the last exception operation 136, 138. If it is not, then the exception subprocess 130 executes the next exception operation 136, 138 at block 704. If the exception operation executed at block 704 is the last exception operation 136, 138, then, at block 708, the second runtime 118 calls the first runtime exception subprocess 128, which may execute as described herein.

### EXAMPLES

In view of the disclosure above, various examples are set forth below. It should be noted that one or more features of an example, taken in isolation or combination, should be considered within the disclosure of this application.

Example 1 is a software integration system, comprising: at least one processor programmed to perform operations comprising: executing a first runtime; executing a second runtime; accessing, by the first runtime, a first message from a first software component to a second software component; executing, by the first runtime a set of first runtime operations based on the first message; responsive to an exception generated by at least one of the set of first runtime operations, calling, by the first runtime, a second runtime exception subprocess to process the exception; executing, by the second runtime, the second runtime exception subprocess to process the exception; and after executing the second runtime exception subprocess to process the exception, executing, by the first runtime, a first runtime exception subprocess to process the exception.

In Example 2, the subject matter of Example 1 optionally includes the executing of the second runtime exception subprocess comprising executing, by the second runtime, at least one operation comprising a data transformation based at least in part on the exception.

In Example 3, the subject matter of any one or more of Examples 1-2 optionally includes the executing of the second runtime exception subprocess comprising executing, by the second runtime, at least one operation comprising writing data to a log based at least in part on the exception.

In Example 4, the subject matter of any one or more of Examples 1-3 optionally includes the set of first runtime operations comprising a policy operation that applies a predetermined policy rule to the first message.

In Example 5, the subject matter of any one or more of Examples 1-4 optionally includes the operations further comprising: accessing, by the first runtime, a second message from the first software component to the second software component; executing, by the first runtime, the set of first runtime operations based on the second message; and after executing the set of first runtime operations, executing, by the second runtime, a set of second runtime operations based on the second message at least one of the set of second runtime operations comprising sending an indication of the second message to the second software component.

In Example 6, the subject matter of Example 5 optionally includes the set of second runtime operations comprising generating a transformation of the second message, the indication of the second message comprising the transformation of the second message.

In Example 7, the subject matter of any one or more of Examples 1-6 optionally includes the set of first runtime operations comprising a first policy operation for managing a message rate and a second policy operation, the executing of the set of first runtime operations based on the first message comprising incrementing, by the first policy operation, a rate counter.

In Example 8, the subject matter of Example 7 optionally includes the executing of the first runtime exception subprocess comprising decrementing the rate counter.

In Example 9, the subject matter of any one or more of Examples 1-8 optionally includes the operations further comprising calling, by the second runtime, the first runtime exception subprocess of the first runtime to process the exception.

Example 10 is a method for providing software integration between a first software component and a second software component using a first runtime and a second runtime, the first runtime and the second runtime being executed by at least one integration platform processor, the method comprising: accessing, by the first runtime, a first message from the first software component to the second software component; executing, by the first runtime a set of first runtime operations based on the first message; responsive to an exception generated by at least one of the set of first runtime operations, calling, by the first runtime, a second runtime exception subprocess to process the exception; executing, by the second runtime, the second runtime exception subprocess to process the exception; and after executing the second runtime exception subprocess to process the exception, executing, by the first runtime, a first runtime exception subprocess to process the exception.

In Example 11, the subject matter of Example 10 optionally includes the executing of the second runtime exception subprocess comprising executing, by the second runtime, at least one operation comprising a data transformation based at least in part on the exception.

In Example 12, the subject matter of any one or more of Examples 10-11 optionally includes the executing of the second runtime exception subprocess comprising executing, by the second runtime, at least one operation comprising writing data to a log based at least in part on the exception.

In Example 13, the subject matter of any one or more of Examples 10-12 optionally includes the set of first runtime operations comprising a policy operation that applies a predetermined policy rule to the first message.

In Example 14, the subject matter of any one or more of Examples 10-13 optionally includes accessing, by the first runtime, a second message from the first software component to the second software component; executing, by the first runtime, the set of first runtime operations based on the second message; and after executing the set of first runtime operations, executing, by the second runtime, a set of second runtime operations based on the second message at least one of the set of second runtime operations comprising sending an indication of the second message to the second software component.

In Example 15, the subject matter of Example 14 optionally includes the set of second runtime operations comprising generating a transformation of the second message, the indication of the second message comprising the transformation of the second message.

In Example 16, the subject matter of any one or more of Examples 10-15 optionally includes the set of first runtime operations comprising a first policy operation for managing a message rate and a second policy operation, the executing of the set of first runtime operations based on the first message comprising incrementing, by the first policy operation, a rate counter.

In Example 17, the subject matter of Example 16 optionally includes the executing of the first runtime exception subprocess comprising decrementing the rate counter.

In Example 18, the subject matter of any one or more of Examples 10-17 optionally includes calling, by the second runtime, the first runtime exception subprocess of the first runtime to process the exception.

Example 19 is a non-transitory machine-readable medium comprising instructions thereon that, when executed by at least one processor, because the at least one processor to perform operations comprising: executing a first runtime; executing a second runtime accessing, by the first runtime, a first message from a first software component to a second software component; executing, by the first runtime a set of first runtime operations based on the first message; responsive to an exception generated by at least one of the set of first runtime operations, calling, by the first runtime, a second runtime exception subprocess to process the exception; executing, by the second runtime, the second runtime exception subprocess to process the exception; and after executing the second runtime exception subprocess to process the exception, executing, by the first runtime, a first runtime exception subprocess to process the exception.

In Example 20, the subject matter of Example 19 optionally includes the executing of the second runtime exception subprocess comprising executing, by the second runtime, at least one operation comprising a data transformation based at least in part on the exception.

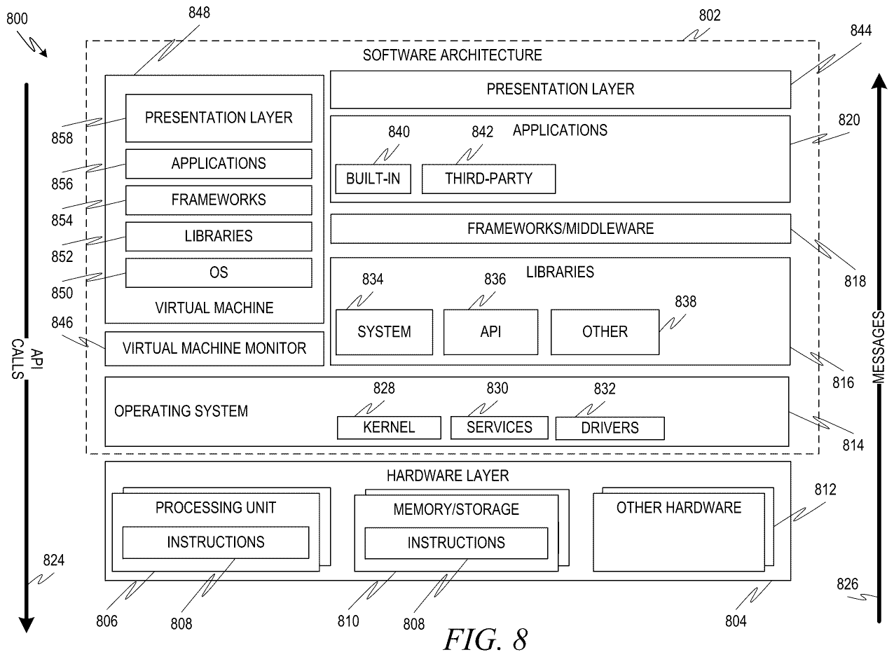

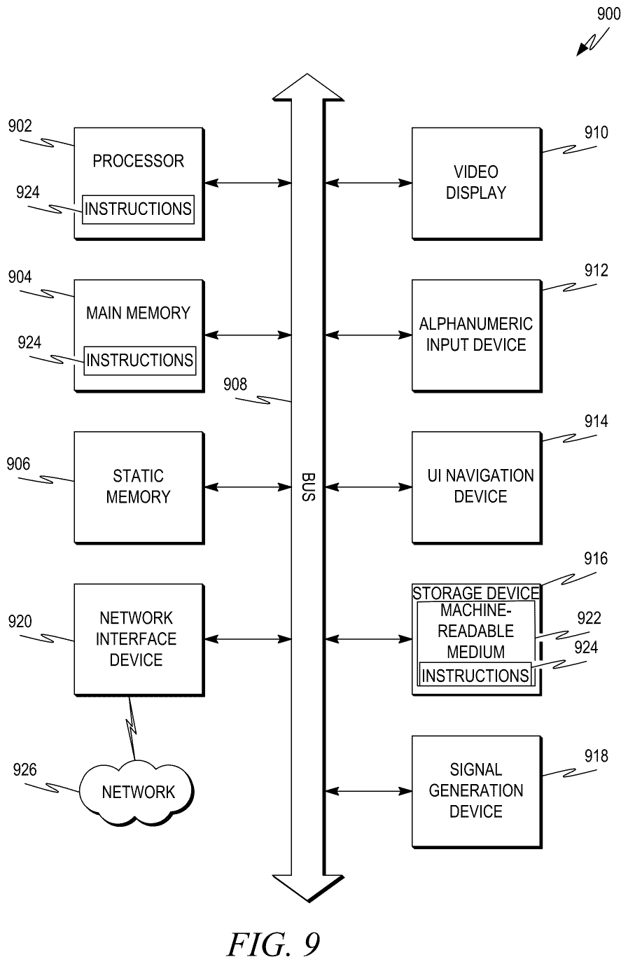

FIG. 8 is a block diagram 800 showing one example of a software architecture 802 for a computing device. The architecture 802 may be used in conjunction with various hardware architectures, for example, as described herein. FIG. 8 is merely a non-limiting example of a software architecture and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 9.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 which represents any other hardware of the hardware layer 804, such as the other hardware illustrated as part of the architecture 802.

In the example architecture of FIG. 8, the software architecture 802 may be conceptualized as a stack of layers where each layer provides particular functionality. For example, the software architecture 802 may include layers such as an operating system 814, libraries 816, middleware layer 818, applications 820, and presentation layer 844. Operationally, the applications 820 and/or other components within the layers may invoke API calls 824 through the software stack and access a response, returned values, and so forth illustrated as messages 826 in response to the API calls 824. The layers illustrated are representative in nature and not all software architectures have all layers. For example, some mobile or special purpose operating systems may not provide a middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The middleware layer 818 (also sometimes referred to as frameworks) may provide a higher-level common infrastructure that may be utilized by the applications 820 and/or other software components/modules. For example, the middleware layer 818 may provide various graphic user interface (GUI) functions, high-level resource management, high-level location services, and so forth. The middleware layer 818 may provide a broad spectrum of other APIs that may be utilized by the applications 820 and/or other software components/modules, some of which may be specific to a particular operating system or platform.

The applications 820 includes built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built-in operating system functions (e.g., kernel 828, services 830 and/or drivers 832), libraries (e.g., system 834, API libraries 836, and other libraries 838), and middleware layer 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856 and/or presentation layer 858. These layers of software architecture executing within the virtual machine 848 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 9 is a block diagram of a machine in the example form of a computer system 900 within which instructions 924 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation (or cursor control) device 914 (e.g., a mouse), a disk drive unit 916, a signal generation device 918 (e.g., a speaker), and a network interface device 920.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media 922.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A software integration system, comprising:
at least one processor programmed to perform operations comprising:
executing a first runtime;
executing a second runtime;
accessing, by the first runtime, a first message from a first software component to a second software component;
executing, by the first runtime a set of first runtime operations based on the first message;
responsive to an exception generated by at least one of the set of first runtime operations, calling, by the first runtime, a second runtime exception subprocess to process the exception;
executing, by the second runtime, the second runtime exception subprocess to process the exception; and
after executing the second runtime exception subprocess to process the exception, executing, by the first runtime, a first runtime exception subprocess to process the exception.

2. The system of claim 1, the executing of the second runtime exception subprocess comprising executing, by the second runtime, at least one operation comprising a data transformation based at least in part on the exception.

3. The system of claim 1, the executing of the second runtime exception subprocess comprising executing, by the second runtime, at least one operation comprising writing data to a log based at least in part on the exception.

4. The system of claim 1, the set of first runtime operations comprising a policy operation that applies a predetermined policy rule to the first message.

5. The system of claim 1, the operations further comprising:
accessing, by the first runtime, a second message from the first software component to the second software component;
executing, by the first runtime, the set of first runtime operations based on the second message; and
after executing the set of first runtime operations, executing, by the second runtime, a set of second runtime operations based on the second message at least one of the set of second runtime operations comprising sending an indication of the second message to the second software component.

6. The system of claim 5, the set of second runtime operations comprising generating a transformation of the second message, the indication of the second message comprising the transformation of the second message.

7. The system of claim 1, the set of first runtime operations comprising a first policy operation for managing a message rate and a second policy operation, the executing of the set of first runtime operations based on the first message comprising incrementing, by the first policy operation, a rate counter.

8. The system of claim 7, the executing of the first runtime exception subprocess comprising decrementing the rate counter.

9. The system of claim 1, the operations further comprising calling, by the second runtime, the first runtime exception subprocess of the first runtime to process the exception.

10. A method for providing software integration between a first software component and a second software component using a first runtime and a second runtime, the first runtime and the second runtime being executed by at least one integration platform processor, the method comprising:
accessing, by the first runtime, a first message from the first software component to the second software component;
executing, by the first runtime a set of first runtime operations based on the first message;
responsive to an exception generated by at least one of the set of first runtime operations, calling, by the first runtime, a second runtime exception subprocess to process the exception;
executing, by the second runtime, the second runtime exception subprocess to process the exception; and
after executing the second runtime exception subprocess to process the exception, executing, by the first runtime, a first runtime exception subprocess to process the exception.

11. The method of claim 10, the executing of the second runtime exception subprocess comprising executing, by the second runtime, at least one operation comprising a data transformation based at least in part on the exception.

12. The method of claim 10, the executing of the second runtime exception subprocess comprising executing, by the second runtime, at least one operation comprising writing data to a log based at least in part on the exception.

13. The method of claim 10, the set of first runtime operations comprising a policy operation that applies a predetermined policy rule to the first message.

14. The method of claim 10, further comprising:
accessing, by the first runtime, a second message from the first software component to the second software component;
executing, by the first runtime, the set of first runtime operations based on the second message; and
after executing the set of first runtime operations, executing, by the second runtime, a set of second runtime operations based on the second message at least one of the set of second runtime operations comprising sending an indication of the second message to the second software component.

15. The method of claim 14, the set of second runtime operations comprising generating a transformation of the second message, the indication of the second message comprising the transformation of the second message.

16. The method of claim 10, the set of first runtime operations comprising a first policy operation for managing a message rate and a second policy operation, the executing of the set of first runtime operations based on the first message comprising incrementing, by the first policy operation, a rate counter.

17. The method of claim 16, the executing of the first runtime exception subprocess comprising decrementing the rate counter.

18. The method of claim 10, further comprising calling, by the second runtime, the first runtime exception subprocess of the first runtime to process the exception.

19. A non-transitory machine-readable medium comprising instructions thereon that, when executed by at least one processor, because the at least one processor to perform operations comprising:
executing a first runtime;
executing a second runtime
accessing, by the first runtime, a first message from a first software component to a second software component;
executing, by the first runtime a set of first runtime operations based on the first message;
responsive to an exception generated by at least one of the set of first runtime operations, calling, by the first runtime, a second runtime exception subprocess to process the exception;
executing, by the second runtime, the second runtime exception subprocess to process the exception; and
after executing the second runtime exception subprocess to process the exception, executing, by the first runtime, a first runtime exception subprocess to process the exception.

20. The medium of claim 19, the executing of the second runtime exception subprocess comprising executing, by the second runtime, at least one operation comprising a data transformation based at least in part on the exception.
